(19) United States
(12) Patent Application Publication
(10) Pub. No.: US 2023/0206372 A1
(43) Pub. Date: Jun. 29, 2023

(54) Fraud Detection Using Aggregate Fraud Score for Confidence of Liveness/Similarity Decisions

(71) Applicant: Jumio Corporation, Palo Alto, CA (US)

(72) Inventors: Armando Ordorica, Montreal (CA); Alix Melchy, Montreal (CA); Artem Voronin, Montreal (CA); Radu Stoian, Montreal (CA)

(21) Appl. No.: 17/564,377

(22) Filed: Dec. 29, 2021

(51) Int. Cl. G06Q 50/26; G06N 20/00

(52) U.S. Cl. CPC G06Q 50/265; G06N 20/00

(57) ABSTRACT

The disclosure includes a system and method for fraud detection in the context of a user submitting, via a client device, a photo of a photo ID and a selfie taken during a step of the verification process. The fraud detection aggregates a variety of different sources of information indicative of potential fraud, such as a liveness signal, a repeated fraudster signal, client device attributes, temporal attributes, country information, and other optional forms of information such as telephone information, IP address etc. A machine learning model may be trained to generate an aggregate fraud score and classify the aggregate fraud score into different risk categories.

### BACKGROUND

The present disclosure relates to verification of identify. More specifically, the present disclosure relates to identity confirmation or verification.

Entities, such as governments, businesses, and individuals, may seek to confirm an identity of a person for any number of reasons including: to protect information or digital assets (e.g., bank accounts, password manager accounts, etc.), to protect physical assets (e.g., doors, vaults, borders, etc.), to comply with laws and regulations (e.g., anti-money laundering or other banking regulations), or other reasons. To confirm an identity, a comparison is often made between an attribute (e.g., face) of the person present and a reference documentation associated with that attribute (e.g., photo ID showing the person's face).

### SUMMARY

This specification relates to methods and systems for fraud detection in which an aggregate fraud score is generated based on a plurality of signals related to verifying an identity of a user submitting, via a client device, at least one photo of a photo ID (e.g., a single photo, two or more photos, or a video of a photo ID) and at least one photo or a video of themselves. The aggregate fraud score may be based on a liveness detection score and a repeat fraudster score. More generally, a variety of client device attributes, photo ID attributes, temporal attributes, and other attributes may be considered in determining an aggregate fraud score. The client device attributes may be used to identify a pseudo device fingerprint signal for the client device.

In some implementations, a machine learning model is trained to generate the aggregate fraud score. At least one threshold may be determined to classify the aggregate fraud score into high fraud risk and low fraud risk instances of identification. In some implementations, at least two thresholds are identified to classify the aggregate fraud score. In some implementations, an aggregate fraud score corresponding to a high fraud risk is automatically rejected whereas an aggregate fraud score corresponding to a low fraud risk is automatically accepted. An intermediate range of fraud scores may be further divided with sub-thresholds into sub-categories for human agent review.

Other implementations of one or more of these aspects include corresponding systems, apparatus, and computer programs, configured to perform the actions of the methods, encoded on computer storage devices.

An example of a method includes generating an aggregated fraud score from two or more attributes indicative of potential fraud in verifying an identity of a user submitting, via a client computing device at least: 1) a photo of a photo ID (more generally at least one photo or a video taken of a photo ID) and 2) at least one photo or a video of the user, which may be taken during a verification step. The aggregated fraud score is classified into one of at least two risk categories for accepting or rejecting the identity of the user. As one example, the two or more attributes may include: 1) a liveness confidence score indicative of a likelihood the photo or video taking during the verification step was that of a live human being present during the verification step; and 2) a repeated fraudster score indicative of fraud based on analyzing the photo in the photo ID and the photo or video taken during the verification step. As another example, the two or more attributes may include device attributes associated with the client computing device of the user corresponding to a device fingerprint; non-photo attributes of the photo ID, including a country associated with the photo ID; temporal attributes including a time of day and day of the week of the verification step; and telephone attributes of the user indicative of potential fraud by the user. In one implementation, the repeated fraudster score accounts for at least one of: i) a fraudulent photo in the photo ID; ii) the face in the photo ID being associated with a different account or a previous attempt at fraud; and iii) the photo or video taken during the verification step having a face associated with a different account or a previous attempt at fraud. In some implements, the method 1) automatically rejects the identity of the user in response to the fraud score exceeding a threshold indicative of high risk of fraud and 2) automatically accepts the identity of the user in response to the fraud score being below a threshold associated with a low risk of fraud.

In some implementations, the method includes training a machine learning fraud model to analyze features in a plurality of signals indicative of potential fraud in verifying an identity of a user submitting, via a client computing device at least: 1) a photo of a photo ID and 2) a photo or a video of the user taken during a verification step. The machine learning fraud model generating an aggregate fraud score and classifying the aggregate fraud score into one of a plurality of risk categories for accepting or rejecting the identity of the user. The machine learning model may be trained to analyze the plurality of attributes with the plurality of attributes including: 1) a liveness confidence score indicative of a likelihood the photo or video taking during the verification step was that of a live human being present during the verification step; and 2) a repeated fraudster score indicative of fraud based on analyzing the photo in the photo ID and the photo or video taken during the verification step; non-photo attributes of the photo ID, including a country associated with the photo ID; temporal attributes including a time of day and day of the week of the verification step. The machine learning model may also be trained to analyze device attributes associated with the client computing device of the user corresponding to a client device fingerprint. In one implementation, the repeated fraudster score accounts for at least one of: i) a fraudulent photo in the photo ID; ii) the face in the photo ID being associated with a different account or a previous attempt at fraud; and iii) the photo or video taken during the verification step having a face associated with a different account or a previous attempt at fraud. In one implementation, the machine learning model comprises an ensemble of decision trees. The machine learning model may also include unsupervised learning for anomaly detection. The method may include automatically rejecting the identity of the user in response to the fraud score exceeding a threshold indicative of high risk of fraud and 2) automatically accepting the identity of the user in response to the fraud score being below a threshold associated with a low risk of fraud. In some implementations, the machine learning model is retrained using label data that includes audit data and data associated with secondary review by human agents for an intermediate risk category. In some implementations, the threshold(s) used to classify the aggregate fraud score into risk categories take into account historic rates of fraud for a particular industry associated with the verification step. In some implementations, the threshold(s) used to classify the aggregate fraud score into risk categories take into account a statistical measure of the relative costs for false positives versus false negatives.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram of one example implementation of a system for detecting liveness in accordance with some implementations.

FIG. 2 is a block diagram of an example computing device in accordance with some implementations.

FIG. 3A is a block diagram of an example fraud detector in accordance with some implementations.

FIG. 3B is a block diagram of an example fraud detector in accordance with some implementations.

FIG. 4 is a block diagram of an example fraud score receiver and preprocessor in accordance with some implementations.

FIG. 5 is a block diagram of an example fraud score-based action engine in accordance with some implementations.

FIG. 6 illustrates an example of a distribution of fraud scores and a selection of threshold and sub-threshold for making action decisions in accordance with some implementations.

FIG. 7 is a flowchart of an example method for training, deploying, and using a fraud score model in accordance with some implementations.

FIG. 8 is a flowchart of an example method for training, deploying, and using a fraud score model with thresholds for auto-accept, auto-reject, and secondary review in accordance with some implementations.

FIG. 9 illustrates an example method illustrating the use of sub-thresholds in accordance with some implementations.

### DETAILED DESCRIPTION

The present disclosure is described in the context of a fraud detector and use cases; however, those skilled in the art should recognize that the fraud detector may be applied to other environments and use cases without departing from the disclosure herein.

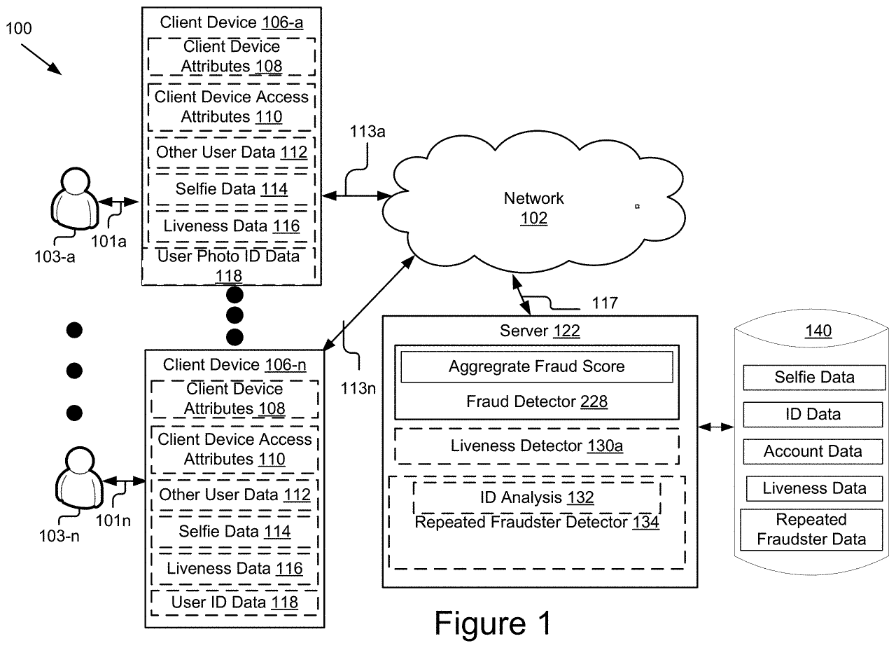

FIG. 1 illustrates a general client-server environment 100. A client device 106 may include a camera, a display, a processor, a memory, and a network, such as a wired or wireless Internet connection. In the most general case, there may be an arbitrary number of client devices (e.g., 106-a . . . 106-n). Examples of client devices 106 may include, but are not limited to, mobile phones (e.g., feature phones, smart phones, etc.), tablets, laptops, desktops, netbooks, portable media players, personal digital assistants, etc. A user 103 may interact 101 with their client device 106 and perform actions such as taking a photo of their photo ID and snapping a photo or short video of themselves. An individual client device may interact with a network 102 via communication link 114 that may, for example, be using wired or wireless communication.

An identity establishment process may be performed for a variety of purposes, such as for purchasing goods or services through an online merchant, applying for government services, etc. To confirm an identity of a user 103 of a client device 106 during an identity establishment process, a comparison is made between a photo ID of the user 103 (e.g., a driver's license, passport, state identification card, or national identification card) and a photo/video (e.g., a selfie) of the person taken during a verification step. For example, a user wishing to establish his/her identity with an entity, e.g., a government agency or a commercial enterprise, the user may be asked to 1) submit a photo of their photo ID (or a set of photos or a video of their photo ID) and 2) also submit his/her image (which may be as a single photo, a set of photos, or a video that may also in some cases be taken live during a step in the identity establishment process). This identity verification process may, in some cases, be implemented through the entity's application on the user's mobile phone or through the entity's portal on a web browser.

When confirming an identity remotely or electronically, determining that the attribute received for comparison to the reference documentation is being received from the actual person with whom the attribute is associated, and not being provided by a third-party fraudster looking to mislead the entity, presents technical challenges, which are not present when a person physically presents himself/herself in the physical world along with his/her identification document for comparison. For example, a user attempting to mislead the entity about his/her identity may submit an image of another person for comparison to the reference documentation using an image of that person taken earlier (e.g., by holding the photo on a stolen ID card to the device's camera, playing a recorded video of someone else's face, etc.). As another example, a user may submit a synthetically generated, or altered, face in front of the camera.

The photo of the photo ID may be analyzed for signs of fraud, such as altering the photo or other portions of the ID. The entity may, depending on the implementation, check that the image thus taken matches the photo on an identification document that the user has submitted (e.g., by a photo, a set of photos, or a video) in order to verify the person's identity, store the image for later identification purposes, or do both. Other data may also be acquired when a user seeks to establish his/her identity. This may include, for example, client device attributes 108 (e.g., type of device, brand, operating system, browser type, memory, etc.). The client device attributes may be used to generate something like a pseudo device fingerprint based on a collection of client device attributes acquired from the client device 106.

Client device access attributes 110 that may be acquired include temporal aspects (e.g., time of day, day of the week). For example, a sin/cosine function may be used to identify cyclic patterns from timestamp data. Some fraudsters are online during certain portions of the day and certain days of the week. If the identity verification is associated with a particular entity (e.g., a particular merchant for an entity verification performed for a purchase) then information on the merchant may be acquired. For example, some merchants tend to specialize in servicing certain geographic areas. There are also often different rates of fraud for different merchants.

In some implementations, additional biometric data or sensor data captured by the client device or a peripheral device may be available from a user.

The system may limit the use of certain types of personal identifiable information. However, in some implementations, personal identifiable information may be used such as IP address. Other user data 114 may include, for example, information provided by the user as part of an application process that includes an identity verification check. This may include a phone number from which a phone connection type may be determined (e.g., cellphone or Voice Over Internet Protocol (VOIP)). Some fraudsters prefer using VOIP phone connections over cellphones. The user may also be required to provide an email address. However, the age of an email account may correlate with fraud. For example, some fraudsters generate new email addresses on the fly. Credit card information may also be optionally considered in an identity verification check for an identity check made as a condition for purchase. Internet provider may be also be considered.

Selfie data 114 may include one or more photos and/or a video clip. In some user cases, the selfie data is taken during a verification step. In this use case, the selfie data 114 is intended to be taken as live data. In other use cases, a merchant may allow users to upload old pictures, which the model is robust enough to detect. Photo analysis may be used to aid in verifying that the selfie is not a photo of a photo or otherwise a false image.

In some implementations, additional liveness data 116 may also be optionally collected that correlated with a photo or a video of the user being taken live by, for example, detecting voluntary or involuntary user actions. For example, a camera associated with the client device may be used to monitor user actions, such as involuntary eye movements, to detect liveness. As another example, a user's voluntary actions may be monitored in response to request made on the user, such as requesting the user to take a picture of themselves with their head or eyes gazing in a particular direction or with a particular expression. Other types of biometric data may also be optionally used to verify liveness.

User photo ID data 112 that is acquired may include a photo of a user's photo ID (e.g., a driver's license, passport, or other local or national government issued photo ID document). More generally the user photo ID data may include a set of photos of a video of the user's photo ID. An individual user photo ID may have associated with it an ID photo, an ID seal, security features, an issuing entity, (e.g., a state for a state driver's license or a country for national ID card or passport, such as a French ID), a name, an address, an ID number, etc. A photo ID may also include a barcode, two-dimensional barcode, QR code, or other machine readable optical code). The passports of many nations have a bar code or other machine-readable optical code on one or more pages of the passport. As another example, many driver's licenses, such as in California, include a barcode (or a two-dimensional barcode) on the back of the driver's license. In the most general case, the photo ID data 112 may also include barcode/optical code data. The barcode/optical code data may also be analyzed to look for signs of potential fraud by, for example, checking that the barcode/optical code data is consistent with the type of ID. Also, the system may perform a check to determine if it has encountered the same barcode/optical code being used by a fraudster, such as by checking whether a barcode/optical code was previously seen for a different account, a different user name, was seen in a rejected identity check, etc.

The overall system thus has several different types of attributes related to potential fraud. These include attributes associated with a client device, attributes of a user ID, attributes of a selfie, and other attributes associated with a user access, such as date/time of an access.

The overall system may include a liveness detector 130 to generate a liveness score. The liveness score may be based on an analysis of the selfie/photos of the user. For example, image analysis may be performed to look for signs that the selfie is a picture of a picture. However, the liveness score generated by liveness detector 130 may also be further based on an analysis of any additional liveness data 116 that is captured. The liveness score thus is indicative of a likelihood that the selfie was taken of a live human being during the identity establishment process. Additionally, the face in the selfie should match the face in the user ID.

The overall system may have a repeated fraudster detector 134 that looks for signs the user was seen before by the system is likely to be a repeat fraudster. For example, a face in a selfie may be suspicious if it corresponds to a face in a previous identity establishment check under a different name. As another example the face in the photo in the user ID may match that of a face in a previously rejected identity establishment check. The photo in the user ID may also be suspicious if it has signs it was altered consistent with potential fraud.

The repeated fraudster detector 134 may include ID analyzer 132 to perform image analysis of a user photo ID and extract facial information and other information from the user ID. A convolutional neural network may be trained to perform facial image recognition and analysis of signs of potential altering of fraud of a photo. The image analysis may also extract other information in the ID (e.g., identity ID type, ID nationality, etc.).

Other types of information may also be acquired. For example, in many cases a photo ID may include not just a face but a portion of the user's outfit. For example, in some photo IDs, a portion of the user's outfit can sometimes be made out, such as the upper portion of a shirt, sweater, suit jacket, blouse, etc. Selfies also often include a portion of a user's outfit. Thus, details like the color, texture, and cut of a shirt, a blouse, or a business suit can sometimes be identified in a photo ID or in a selfie. This outfit information is another type of signal that may be analyzed to look for signs of potential fraud. For example, there are many articles describing differences in men's shirts and suits in different countries. As one example, many articles describe differences in men's styles of dress shirts and suits between the United States, France, Italy, and the United Kingdom. For example, American men's clothing styles often have different collar styles and different color schemes than in many European countries.

In some implementations, the system analyzes potential matches in the outfit worn in both the selfie and the photo ID. This could, in principle, be an analysis for a match of a particular outfit (e.g., a red turtleneck sweater in the selfie and a red turtleneck sweater in the photo ID; a fashion scarf in the selfie matching a fashion scarf in the photo ID). But more generally, it could be an analysis of a match/mismatch between outfit attributes/features. For example, an outfit in a selfie may have fashion style attributes of country “A” but the photo ID may have an outfit matching fashion style attributes of country “B.” For example, a selfie may have an outfit matching attributes of American fashion styles which might be inconsistent with a French photo ID have a photo of the user in an outfit have outfit attributes associated with French fashion styles. As yet another possibility, if a selfie photo or a photo ID photo that had an unusual outfit feature (e.g., a highly unusual shirt or scarf), an analysis could be performed to look for examples of fraudsters who used photos with similarly unusual outfit features (e.g., a matching unusual shirt or scarf).

Another type of information that may be acquired from a photo is background information. A selfie might include not just the user's face but also in some cases show background details of a room the selfie was taking, such as details about the floor, the walls, windows, doors, furniture, and decorations. In some cases, the background in a selfie may have background details distinctive enough that it can be identified as being taken in a unique room or office. For example, a fraudster might use the same office or home repeatedly such the system has seen photos with similar background details before.

In other cases, the backgrounds of selfies may be analyzed to look for details that are associated with particular countries. For example, for a variety of historical reasons, door designs, window designs, and popular choices for floor coverings (e.g., tile, wood, or carpet) often very between countries. Some color schemes are more popular in some countries that others. There are also sometimes differences between popular choices of wall coverings in different countries. Furniture designs can also vary between countries.

The fraud detector 228 outputs a ranked aggregate fraud score within a bounded range. Thresholds may be defined corresponding to different categories of risk.

The fraud detector 228 may be implemented using a variety of machine learning techniques, including supervised learning, unsupervised learning, semi-supervised learning, etc. Additionally, the fraud detector 228 may include more than one type of model to address different potential fraud threats.

In one implementation, an ensemble of decision trees is used. The ensemble of decision trees may be used in a random forest to classify the votes from many different trees. In some implementations, a random forest is used in combination with an XGboosted tree, where XGBoost is a decision-tree-based ensemble Machine Learning algorithm that uses a gradient boosting framework. A random forest is a machine learning algorithm useful for classification that combines the output of multiple decision trees to reach a single output. It is an ensemble learning method made up of a of a set of decision trees with their predictions aggregated to determine the most popular result. In some implementations, after each retraining of the machine learning models for the fraud detector, the random forest outputs results from the best splitters based on an entropy consideration in terms of how good they are at organizing the fraud risk into different categories and identifies the top features associated with fraud risk in different categories.

The fraud detector 228 may also give a higher weight to more recent training data in selecting samples for training the machine learning models. This facilitates tracking trends in fraudster behavior. For example, an exponential or other weighing function may be used to select more recent training data over older training data.

The fraud detector 228 may include features for detecting suspicious trends by tracking velocity and acceleration for new behavior, such as unexpected traffic. For example, fraudsters may target a particular merchant, change the time of day they operate, change the types of client devices and internet service providers they use, etc. Fraudsters are always looking for security weaknesses, but once successful, tend to follow the same pattern as long as it works. This means that there may be large and fairly sudden changes in transaction behavior. To address this issue, the fraud detector 228 may include unsupervised anomaly detection, searching for velocity and acceleration in attributes of transactions. For example, fraudsters may change behavior and target a particular merchant as one example. Providing a capability for unsupervised anomaly detection provides an additional type of fraud detection.

In some implementations, semi-supervised learning may optionally be included to cluster features, cluster trends in features, and perform clustering across features. Including clustering is another way to improve robustness of the fraud detector.

In some implementations, the fraud score model 242 assigns categories to country information. This may include identifying a country associated with an individual identification verification based on country information associated with the user photo ID, the merchant associated with the verification check, or other information such as an IP address. For example, some countries have a relatively low risk of fraud while others may have a higher risk of fraud. In one implementation, countries are grouped into high risk and low risk categories for fraud. A logical statement or a label code may be used to apply this information into the mode. As one example, a correlation between fraud and country may be identified, along with a sample size, in order to identify a most relevant subset of high risk and low risk countries for fraud.

The fraud detector 228 may be implemented on a server 122, although more generally it could be implemented in other parts of the system 100 as well. The fraud detector 228 generates an aggregate fraud score by aggregating a set of different signals indicative of potential fraud, which is a number within a bounded range (e.g., 0 to 1; 0 to 10; 0 to 1000).

The fraud detector 228 may make fraud detection decisions based on a variety of input signals and associated probabilities. The fraud detector 228 may include a variety of models to generate an aggregate fraud score that aggregates available fraud input signals. Thus, the potential accuracy and robustness to detecting fraud is increased, as well as the robustness to adapt to new threats. The output of the fraud detector may be used to classify an individual identity assessment instance for an individual into categories of fraud risk, such as high, medium, and low.

The overall system may include a database 140 that stores selfie data, photo ID data, account data, liveness data, repeated fraudster data, etc. That is, while there are individual instances in which an identity establishment process is performed, an overall system may handle a large number of identity establishment checks and store data to aid in performing repeated fraudster detection and for improvement the models used in the system.

It should be understood that there may be any number of client devices 106. It should be understood that the system 100 depicted in FIG. 1 is provided by way of example and the system 100 and/or further systems contemplated by this present disclosure may include additional and/or fewer components, may combine components and/or divide one or more of the components into additional components, etc. For example, the system 100 may include any number of client devices 106, networks 102, or servers 122.

The network 102 may be a conventional type, wired and/or wireless, and may have numerous different configurations including a star configuration, token ring configuration, or other configurations. For example, the network 102 may include one or more local area networks (LAN), wide area networks (WAN) (e.g., the Internet), personal area networks (PAN), public networks, private networks, virtual networks, virtual private networks, peer-to-peer networks, near field networks (e.g., Bluetooth®, NFC, etc.), cellular (e.g., 4G or 5G), and/or other interconnected data paths across which multiple devices may communicate.

The server 122 is a computing device that includes a hardware and/or virtual server that includes a processor, a memory, and network communication capabilities (e.g., a communication unit. The server 122 may be communicatively coupled to the network 102, as indicated by signal line 117. In some implementations, the server 122 may send and receive data to and from other entities of the system 100 (e.g., one or more client devices 106).

Other variations and/or combinations are also possible and contemplated. It should be understood that the system 100 illustrated in FIG. 1 is representative of an example system and that a variety of different system environments and configurations are contemplated and are within the scope of the present disclosure. For example, various acts and/or functionality may be moved from a server to a client, or vice versa, data may be consolidated into a single data store or further segmented into additional data stores, and some implementations may include additional or fewer computing devices, services, and/or networks, and may implement various functionality client or server-side. Furthermore, various entities of the system may be integrated into a single computing device or system or divided into additional computing devices or systems, etc.

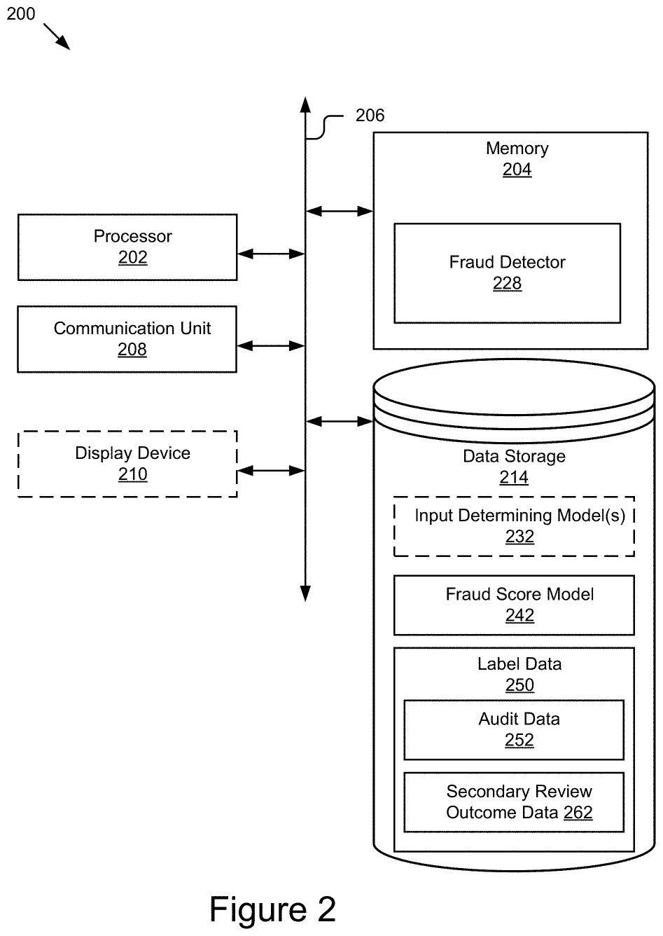

FIG. 2 is a block diagram of an example computing device 200 including an instance of the fraud detector 228. In the illustrated example, the example computing device 200 includes a processor 202, a memory 204, a communication unit 208, and a display 210.

The processor 202 may execute software instructions by performing various input/output, logical, and/or mathematical operations. The processor 202 may have various computing architectures to process data signals including, for example, a complex instruction set computer (CISC) architecture, a reduced instruction set computer (RISC) architecture, and/or an architecture implementing a combination of instruction sets. The processor 202 may be physical and/or virtual, and may include a single processing unit or a plurality of processing units and/or cores. In some implementations, the processor 202 may be capable of generating and providing electronic display signals to a display device, supporting the display of images, capturing and transmitting images, and performing complex tasks and determinations. In some implementations, the processor 202 may be coupled to the memory 204 via the bus 206 to access data and instructions therefrom and store data therein. The bus 206 may couple the processor 202 to the other components of the computing device 200 including, for example, the memory 204, the communication unit 208.

The memory 204 may store and provide access to data for the other components of the computing device. The memory 204 may be included in a single computing device or distributed among a plurality of computing devices. In some implementations, the memory 204 may store instructions and/or data that may be executed by the processor 202. The instructions and/or data may include code for performing the techniques described herein. For example, in one implementation, the memory 204 may store an instance of the fraud detector 228.

The memory 204 is also capable of storing other instructions and data, including, for example, an operating system, hardware drivers, other software applications, databases, etc. The memory 204 may be coupled to the bus 206 for communication with the processor 202 and the other components of the computing device 200.

The memory 204 may include one or more non-transitory computer-usable (e.g., readable, writeable) device, a static random access memory (SRAM) device, a dynamic random access memory (DRAM) device, an embedded memory device, a discrete memory device (e.g., a PROM, FPROM, ROM), a hard disk drive, an optical disk drive (CD, DVD, Blu-ray™, etc.) mediums, which can be any tangible apparatus or device that can contain, store, communicate, or transport instructions, data, computer programs, software, code, routines, etc., for processing by or in connection with the processor 202. In some implementations, the memory 204 may include one or more of volatile memory and non-volatile memory. It should be understood that the memory 204 may be a single device or may include multiple types of devices and configurations.

A data storage 214 may store data related to the fraud detector 228. For example, depending on implementation details, it may include a variety of input determining models 232, such as liveness model, a repeated fraudster model, etc. The input determining models 232 are illustrated in dashed lines as options because the fraud detector 228 may receive input signals generated by other entities in the system that generate, for example, a confidence level for liveness, repeat fraudster signals, etc.

A fraud score model 242 generates a single (aggregate) fraud score based on a set of input signals. The fraud score model may also further a fraud score, and apply scaling and two or more thresholds to classify the fraud score into one of at least three different classifications including automatically accept, automatically reject, and escalate to agent review. The fraud score model 242 includes one or more machine learning models trained and applied to generate an aggregate fraud score from two or more input signals.

Label data 250 may include a variety of data source for retraining the fraud score model 242. The label data 250 may include audit data 252. For example, the audit data may include data audits for a selection of previous instances in which the fraud score model 242 identified an identity check into categories corresponding to being approved, rejected, or sent to human review. In some implementations, instances in which the identity check is sent to human review has a set of further checks for an agent to perform. The fraud score model 242 may further identify high/medium/low subcategories for human review. Each of these subcategories may have a different set of checks for human reviewers to perform. In any case, the outcome of secondary review by human agents results in secondary review outcome data 262.

During retraining of the fraud score model, the audit data 252 may be used as one source of retraining data. The secondary review outcome data 262 may also be used as retraining data. However, the weight assigned to the secondary review outcome data 262 may be different than that of the audit data 252. For example, consider the case where there are high-medium-low subcategories for agent review. Each subcategory may have different checks performed based on its risk. The analysis performed would typically be different than for audit data, and hence a weight function may be used to optimized the weights given to audit data and secondary review outcome data in retraining the fraud detector model.

The communication unit 208 is hardware for receiving and transmitting data by linking the processor 202 to the network 102 and other processing systems. The communication unit 208 receives data and transmits the data via the network 102. The communication unit 208 is coupled to the bus 206. In one implementation, the communication unit 208 may include a port for direct physical connection to the network 102 or to another communication channel. For example, the computing device 200 may be the server 122, and the communication unit 208 may include an RJ45 port or similar port for wired communication with the network 102. In another implementation, the communication unit 208 may include a wireless transceiver (not shown) for exchanging data with the network 102 or any other communication channel using one or more wireless communication methods, such as IEEE 802.11, IEEE 802.16, Bluetooth® or another suitable wireless communication method.

In yet another implementation, the communication unit 208 may include a cellular communications transceiver for sending and receiving data over a cellular communications network such as via short messaging service (SMS), multimedia messaging service (MMS), hypertext transfer protocol (HTTP), direct data connection, WAP, e-mail or another suitable type of electronic communication. In still another implementation, the communication unit 208 may include a wired port and a wireless transceiver. The communication unit 208 also provides other connections to the network 102 for distribution of files and/or media objects using standard network protocols such as TCP/IP, HTTP, HTTPS, and SMTP as will be understood to those skilled in the art.

The display 210 is a conventional type such as a liquid crystal display (LCD), light emitting diode (LED), touchscreen, or any other similarly equipped display device, screen, or monitor. The display 210 represents any device equipped to display electronic images and data as described herein.

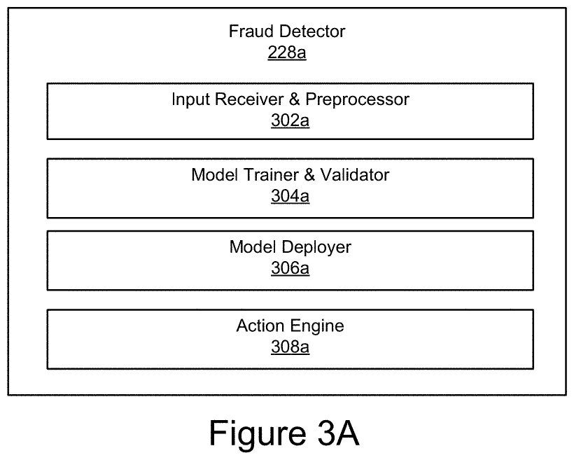

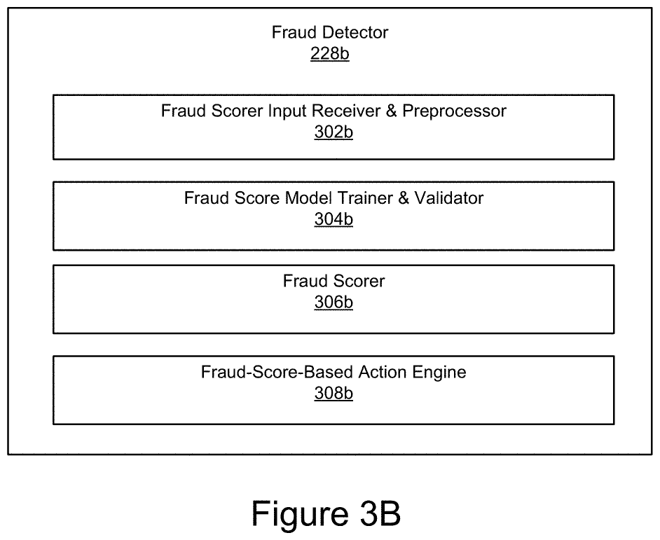

Referring now to FIG. 3A, a block diagram of an example of a fraud detector 228 is illustrated in accordance with one implementation. In this example AI/ML, components are illustrated a high level of abstraction for implementing models for generating and applying an aggregate fraud score. The fraud detector may implement models for liveness detection, repeated fraud detection, etc. As illustrated in FIG. 3A, the fraud detector 228 may include an input receiver and preprocessor 302 to receive input signals indicative of potential fraud and perform any pre-processing of input signals. A model trainer and validator unit 304 may train and validate the machine learning models that are used. A model deployer 306 implements model deployment. Action engine 308 determines actions for identity verification checks (e.g., accept, reject, flag for agent review).

FIG. 3B illustrates another implementation of the fraud detector 228. Other components may generate input signals such as a liveness signal, repeat fraudster signal, etc. Block 302 is a fraud scorer input receiver and preprocessor that receives the input fraud detections signals and performs any necessary preprocessing or feature extraction. A fraud score model trainer and validator 304 may train an ensemble of trees or a random forest. However, more generally a variety of different types of models may be supported. The fraud scorer 306 generates a fraud score, which may be a number in a bounded range. A fraud-score-based action engine 308 may determine actions based on the fraud score, such as automatically accept, automatically reject, or flag for agent review.

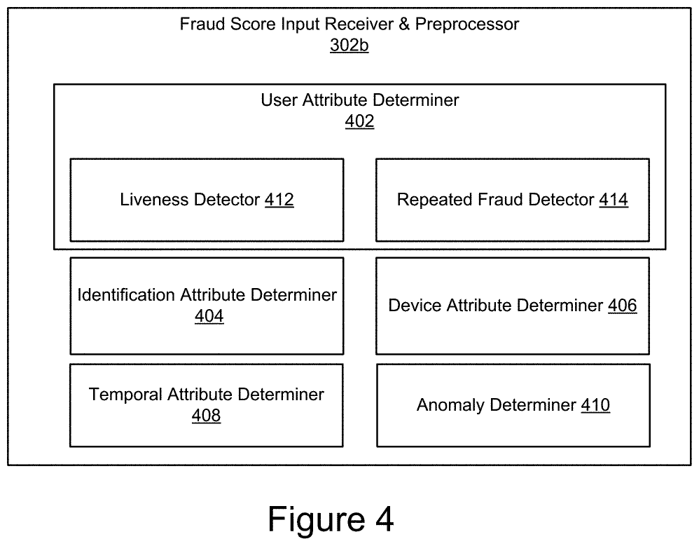

FIG. 4 illustrates an example implementation of a fraud score input receiver and preprocessor 302. A user attribute determiner 402 determines user attributes from received inputs. Examples of user attributes include a selfie image/video, biometric or live sensor data, or other non-sensor-based attributes associated with the user (e.g., email address, email age), etc. The user attribute determiner 402 may include a liveness detector 412 and a repeated fraudster detector 414.

An identification attribute determiner 404 may identify attributes of an ID (e.g., nationality associated with ID, such as a French ID card). An anomaly determiner may detect velocity and acceleration in transaction metrics.

A device attribute determiner 406 may identify device attributes such as a type of browser, OS, device memory, brand, etc. Device attributes may also include a phone carrier (e.g., VOIP or cell phone carrier). Nationality, in terms of the location of the client device at the time of an identity check, may also be a device attribute.

A temporal attribute determiner 404 may, for example, look for temporal patterns (e.g., cycles) from timestamp data. For example, a sin or cosine function may be used to look for cyclic behavior associated with fraudster operation at certain times of the day and certain days of the week. For example, Fraudsters sometimes operate at certain times of the day and certain days of the week.

An anomaly determiner 410 looks for anomalies in a set of input signals that may signal a change in fraudster behavior. This may include a velocity and acceleration analysis as previously discussed.

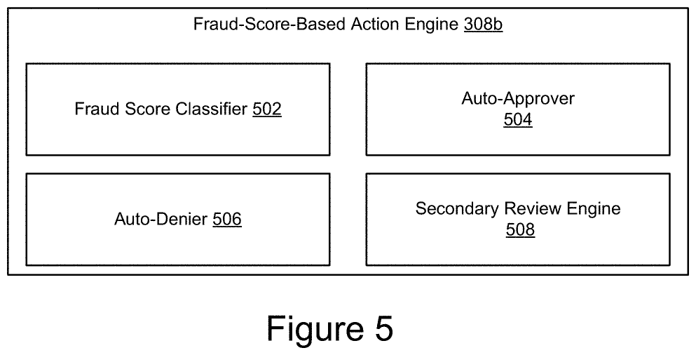

FIG. 5 illustrates an implementation of the fraud score-based action engine 308. A fraud score classifier 502 classifies the score by applying, for example, one or more thresholds to generate different categories of risk. In theory a single threshold could be used in the classification. However, two or more thresholds may be used to define categories of fraud scores for automatic approval, automatic denial, or human secondary review. The classification may include a high/medium/low subclassification. The fraud score classifier 502 receives the fraud score and classifies for approval, denial, or human review. It may apply a High/Medium/Low subclassification to those classified for human review. Classification may be provided as audit data used for (re)training and/or validation.

The selection of the threshold(s) may be customized for a particular merchant to account for historic rates in fraud and taking in account the costs of false positives and false negatives. It may include cost-based thresholds that take into account the ratio between false positives and false negatives, as well as the differences in costs associated with false positives and false negatives. For example, falsely identifying a fraudster as a legitimate user has an associated worst-case cost, such as the fraudster maxing out a credit limit. On the other incorrectly identifying a legitimate user as a fraudster may result in the legitimate user never doing business with the merchant, corresponding to a potential lifetime loss of a legitimate customer's business.

The classification performed by the fraud score classifier 502 may be customized for a particular merchant based on common fraud rates for the merchant/industry and one or more statistical techniques to customize the thresholds.

The auto approver 504 approves/allows transaction (e.g. financial transaction, login, account creation, etc.) or sends message to cause approval/allowance. The auto approver 504 acts in response to a fraud score corresponding to a non-fraudulent transaction.

The auto denier 506 denies/stops transaction or sends message to cause denial. The auto denier 506 act in response to a fraud corresponding to fraud being highly likely.

A secondary review engine 508 facilitates secondary (e.g., human) review. The human review prompted may vary based on high-medium-low (H/M/L) classification. For example, which actions or how many actions are taken by the human reviewer. The outcome of human review may be provided as human-review outcome data used for (re)training and/or validation. The outcome data for each of the H/M/L classes may be weighted differently when (re)training the fraud scoring model.

A human-reviewer action model (not shown in FIG. 5) may be trained and applied to determine the “best” action(s) for a human reviewer to take based on the H/M/L classification and which factor(s) were identified/scored as indicative of fraud.

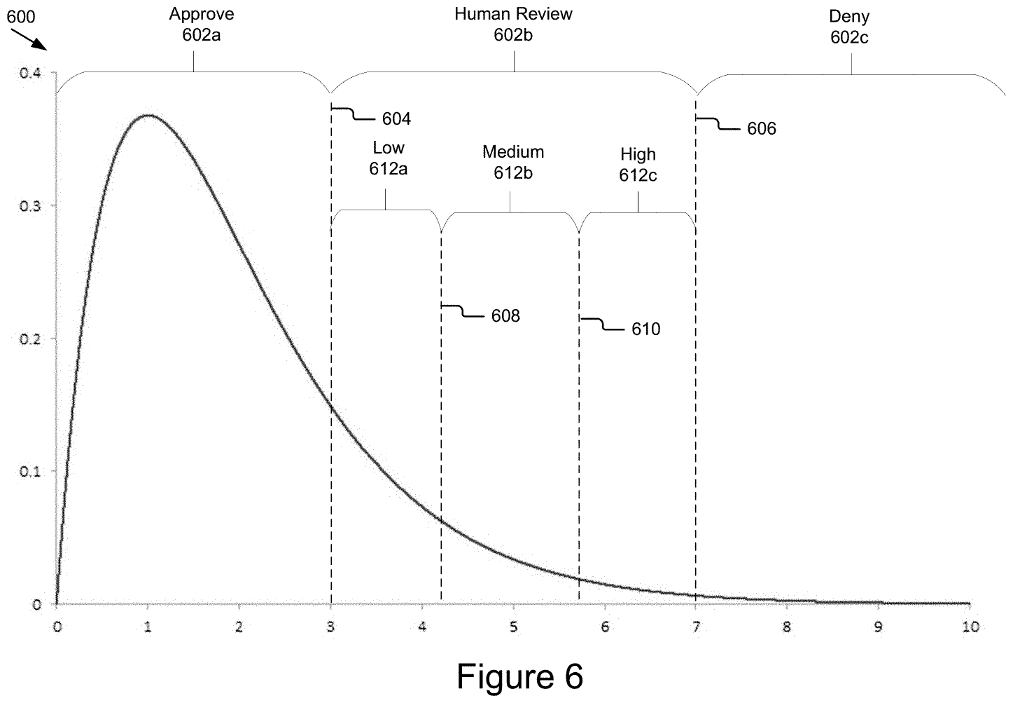

An algorithm for assigning thresholds for ranges of various actions and levels of human review will now be described with regards to FIG. 6. FIG. 6 illustrates an example distribution of fraud scores over a range of fraud scores from 0 to 10. This example illustrates a skewed distribution with a long tail. In many merchant scenarios, the fraud score distribution will have a large percentage of transactions in a range for which the risk of fraud is low. The long tail includes a range farther out with a high risk of fraud. There is typically an intermediate region of moderate risk of fraud. This corresponds to the approve range 602a, a deny range 602c, and a human review range 602b. The range 602b may be further sub-classified into a low risk bucket 612a for human review, a medium risk bucket 612b for human review, and a high risk bucket 612c for human review.

One aspect of FIG. 6 is that the thresholds and ranges may be dynamical adjusted (e.g., by machine learning) to customize the thresholds for particular merchants/circumstances to ensure a certain percentage or number of transactions fall into certain buckets. For example, some merchants/industries have historically lower average rates of fraud than others. The assignment of threshold may take into account average rates of fraud. For example, the scaling of the curve in FIG. 6 could be adapted for different merchants based on data of fraud rates for a particular merchant such that the deny range 602 has a close relationship with data on rates of fraud for the particular merchant/industry.

The thresholds in FIG. 6 may also be customized to take into account the risk/benefit aspect of selecting the thresholds in regards to false positives and false negatives. For example, suppose a credit card has a $5,000 limit. The cost of a false negative (e.g., a fraudster is not detected) may be $5,000 (e.g., a credit card limit). However, the cost of a false positive (legitimate user denied a transaction) may be much smaller in many cases (e.g., a $200 attempted purchase that is denied).

Thus, merchant-based normalization of the distribution may be performed by the fraud score model or the classifier. This approach takes into account fraud rate prevalence within an historical time period. This design choice includes customizing threshold values and sub-thresholds be merchant specific. It may also include taking into account the cost-benefit related to different costs associated for false positives and false negatives, which in some cases is also merchant specific. The general shape of the fraud distribution will tend to be similar for different merchants but some merchants will have more instances in the deny region 602 and threshold 606 to be consistent with historic fraud. The sub-threshold 608 and 610 may be based on standard deviations from the fraud prevalence.

A variety of statistical techniques may be used to adapt the thresholds in FIG. 6, such as by defined a merchant-specific f1 score that takes into account the different costs associated for false positives and false negatives. Consider the example of the cost of a false negative (e.g., a fraudster is not detected) is $5,000 (e.g., a credit card limit). However, the cost of a false positive (legitimate user denied a transaction) may be much smaller in many cases (e.g., a $200 attempted purchase that is denied). However, a different merchant may lose a different amount of falsely rejecting a user (e.g., $500).

That is, the threshold may be dynamic, merchant specific, and account for changes in fraud distribution over time, merchant specific fraud instances over time, and merchant specific differences in relative costs of false positives and false negatives.

In some implementations, selections of thresholds are valuated and test in terms of their predictive value. That is, the selections of the thresholds illustrated in FIG. 6 can be implemented using statistical principles but may also be dynamically adjusted, tested, and validated to establish their predictive value.

### Example Methods

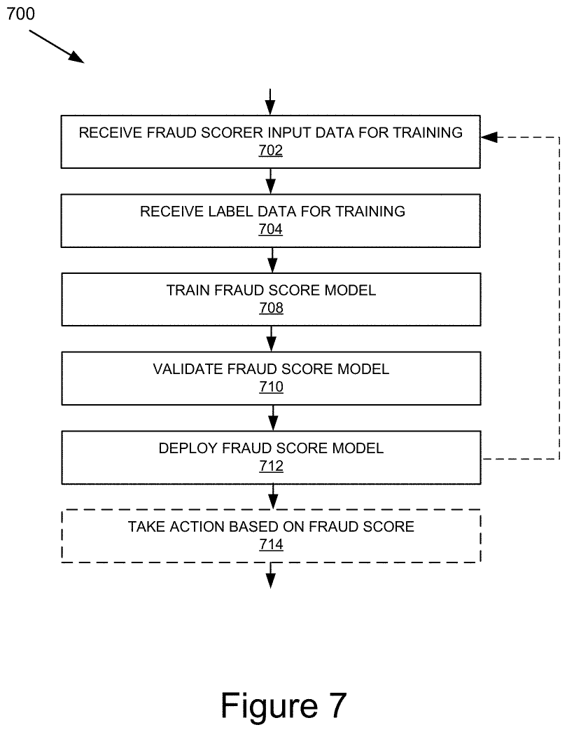

FIGS. 7-9 are flowcharts of example methods that may, in accordance with some implementations, be performed by the systems described above with reference to FIGS. 1-5. The methods are provided for illustrative purposes, and it should be understood that many variations exist and are within the scope of the disclosure herein.

FIG. 7 is a flowchart of an example method 700 for generating a fraud score and taking an action based on the fraud score. In block 702, fraud scorer input data is received for training. In block 704, label data is received for training. In block 708, the combined training data is used to train a fraud score model. In block 710, the fraud score model is validated. That is, the effectiveness of the model is tested against test data to validate that the trained model works properly. In block 712, the fraud score model is deployed. That it is, it is used to generate fraud scores for live input data. A champion challenger deployment scheme may be used in regards to deploying improved fraud score models. As indicated by the dashed line, there may be retraining of the fraud score model. In a case, as indicated in block 714, a fraud score generated from the deployed fraud score model may be used to take further action, such as accepting, rejecting, or flagging for agent review an individual identity check based on its fraud score.

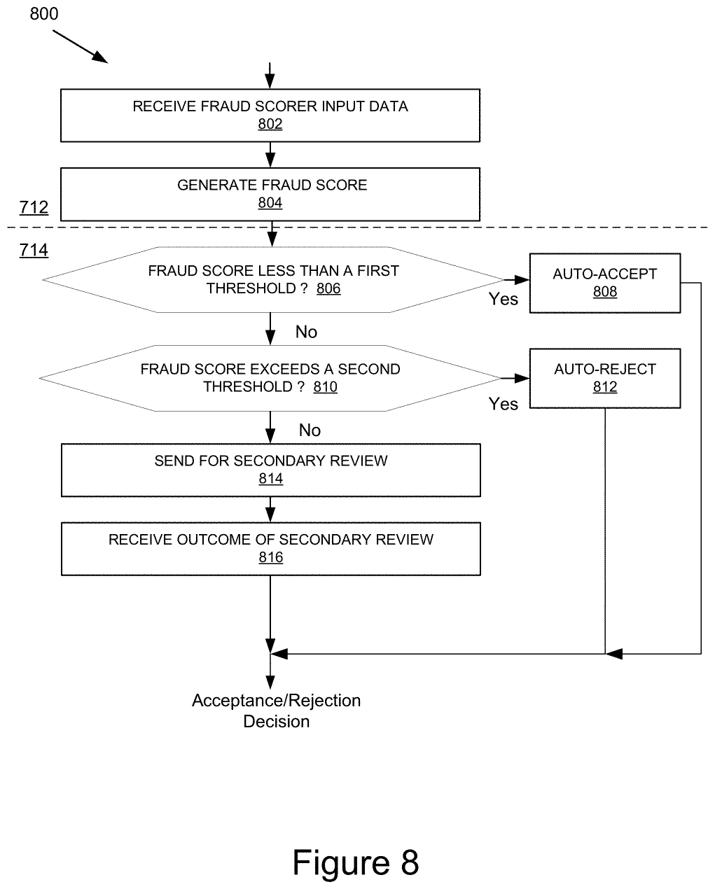

FIG. 8 is a flowchart of an example method 800 for an implementation corresponding to a narrower implementation of the method of FIG. 7. Block 712 for deploying the fraud score model may further include receiving fraud scorer input data in block 802 and generates a fraud score in block 804. Block 714 includes using two threshold scores to determine auto-accept, auto-rejection and send for secondary review options. In block 806, a determination is made if the fraud score satisfied a first threshold condition. This may, for example, be that the fraud score is less than a first threshold value corresponding to a low risk of fraud. If yes, there is an auto-accept as in block 808. If not, a determination is made in block 810 if the fraud score exceeds a second threshold corresponding to a high risk of fraud. If so, there is an auto-reject in block 812. If not, there is a secondary review in block 814 in which human agents run one or more additional checks and a determination whether to issue an acceptance or a rejection. This results in an action for each identity check being an acceptance or a rejection.

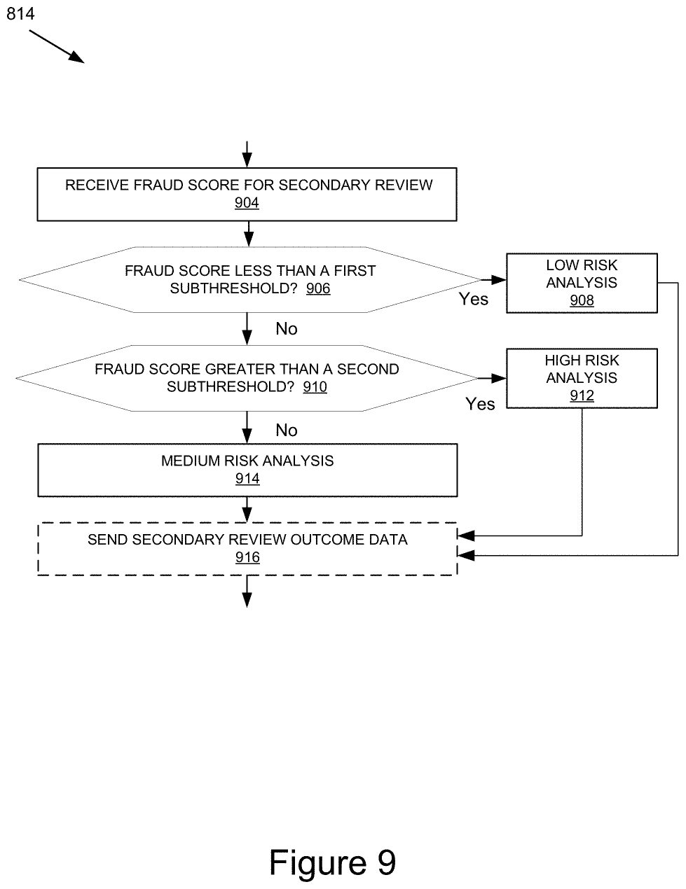

FIG. 9 is a flowchart of an example method 900 for an implementation of step 814 from FIG. 8 in regard to secondary human reviewers. In block 902 a fraud score is received for secondary review. A first determination is made if it is less than a first subthreshold. If yes then a low risk analysis is performed in block 908. If no, then a determination is made in block 910 if the fraud score is greater than a second subthreshold. If yes, a high risk analysis is performed in block 912. If no, a medium risk analysis is performed in block 914. The process ends by sending the secondary review outcome date in block 916.

Other Considerations

It should be understood that the above-described examples are provided by way of illustration and not limitation and that numerous additional use cases are contemplated and encompassed by the present disclosure. In the above description, for purposes of explanation, numerous specific details are set forth in order to provide a thorough understanding of the present disclosure. However, it should be understood that the technology described herein may be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

Reference in the specification to “one implementation” or “an implementation” or “some implementations” means that a particular feature, structure, or characteristic described in connection with the implementation is included in at least one implementation. The appearances of the phrase “in some implementations” in various places in the specification are not necessarily all referring to the same implementations.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of a hardware implementation, a software implementation, or implementations containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including, but not limited to, keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), Web Socket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As should be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats.

Furthermore, the modules, routines, features, attributes, methodologies, engines, and other aspects of the disclosure can be implemented as software, hardware, firmware, or any combination of the foregoing. Also, wherever an element, an example of which is a module, of the specification is implemented as software, the element can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A computer implemented method, comprising:
generating an aggregate fraud score from a plurality of attributes indicative of potential fraud in verifying an identity of a user submitting, via a client computing device at least: 1) at least one photo of a photo ID and 2) at least one photo or a video of the user taken during a verification step; and
classifying the aggregate fraud score for the user into one of a plurality of risk categories for accepting or rejecting the identity of the user.

2. The computer implemented method of claim 1, wherein the plurality of attributes comprises: 1) a liveness confidence score indicative of a likelihood a photo or video taking during the verification step was that of a live human being present during the verification step; and 2) a repeated fraudster score indicative of fraud based on analyzing a photo in the photo ID and a photo or video taken during the verification step.

3. The computer implemented method of claim 2, where in the plurality of attributes further comprises; 3) device attributes associated with the client computing device of the user; 4) non-photo attributes of the photo ID, including a country associated with the photo ID.

4. The computer implemented method of claim 3, wherein the plurality of attributes further comprise temporal attributes including a time of day and day of the week of the verification step.

5. The computer implemented method of claim 3, wherein the plurality of attributes further comprise at least one of telephone attributes of the user indicative of potential fraud by the user.

6. The computer implemented method of claim 1, wherein the repeated fraudster score accounts for at least one of: i) a fraudulent photo in the photo ID; ii) the face in the photo ID being associated with a different account or a previous attempt at fraud; and iii) the photo or video taken during the verification step having a face associated with a different account or a previous attempt at fraud.

7. The computer implemented method of claim 1, further comprising: 1) automatically rejecting the identity of the user in response to the fraud score exceeding a threshold indicative of high risk of fraud and 2) automatically accepting the identity of the user in response to the fraud score being below a threshold associated with a low risk of fraud.

8. A computer implemented method, comprising:
a machine learning fraud model trained to analyze features in a plurality of signals indicative of potential fraud in verifying an identity of a user submitting, via a client computing device at least: 1) at least one photo of a photo ID and 2) at least one photo or a video of the user taken during a verification step;
the machine learning fraud generating an aggregate fraud score and classifying the aggregate fraud score into one of a plurality of risk categories for accepting or rejecting the identity of the user.

9. The computer implemented method of claim 8, wherein the machine learning model is trained to analyze the plurality of attributes with the plurality of attributes including: 1) a liveness confidence score indicative of a likelihood the photo or video taking during the verification step was that of a live human being present during the verification step; and 2) a repeated fraudster score indicative of fraud based on analyzing a photo in the photo ID and a photo or video taken during the verification step; non-photo attributes of the photo ID, including a country associated with the photo ID; temporal attributes including a time of day and day of the week of the verification step;

10. The computer implemented method of claim 9, wherein the plurality of attributes further comprises; 3) device attributes associated with the client computing device of the user;

11. The computer implemented method of claim 8, wherein the repeated fraudster score accounts for at least one of: i) a fraudulent photo in the photo ID; ii) the face in the photo ID being associated with a different account or a previous attempt at fraud; and iii) the photo or video taken during the verification step having a face associated with a different account or a previous attempt at fraud.

12. The computer implemented method of claim 8, wherein the machine learning model comprises an ensemble of decision trees.

13. The computer implemented method of claim 8, wherein the machine learning model comprises unsupervised learning for anomaly detection.

14. The computer implemented method of claim 8, further comprising: 1) automatically rejecting the identity of the user in response to the fraud score exceeding a threshold indicative of high risk of fraud and 2) automatically accepting the identity of the user in response to the fraud score being below a threshold associated with a low risk of fraud.

15. The computer implemented method of claim 14, wherein the machine learning model is retrained using label data that includes audit data and data associated with secondary review by human agents for an intermediate risk category.

16. The computer implemented method of claim 8, further comprising generating at least two thresholds for classifying the aggregate fraud score into one of a plurality of risk categories for accepting or rejecting the identity of the user, where the at least two thresholds take into account historic rates of fraud for a particular industry associated with the verification step.

17. The computer implemented method of claim 16, wherein the at least two thresholds take into account a statistical measure of the relative costs for false positives versus false negatives.

18. A system comprising:
a processor; and
a memory, the memory storing instructions that, when executed by the processor, cause the system to:
generate a machine learning fraud model and train the machine learning fraud model to aggregate fraud signals to generate an aggregate fraud score;
the machine learning fraud model being trained to analyze features in a plurality of signals indicative of potential fraud in verifying an identity of a user submitting, via a client computing device at least: 1) at least one photo or a video of a photo ID and 2) at least one photo or a video of the user taken during a verification step;
the system generating an aggregate fraud score and classifying the aggregate fraud score into one of a plurality of risk categories for accepting or rejecting the identity of the user.

19. The system of claim 18, further comprising generating at least one threshold for classifying the aggregate fraud score and accepting or rejecting the identity of the user.

20. The system of claim 19, wherein the at least one threshold comprises at least two thresholds for classifying the aggregate fraud score into one of a plurality of risk categories for accepting or rejecting the identity of the user, wherein the at least two thresholds take into account historic rates of fraud for a particular industry associated with the verification step.

21. The system of claim 20, wherein the at least two thresholds take into account a statistical measure of the relative costs for false positives versus false negatives.
